(19) United States
(12) Patent Application Publication
(10) Pub. No.: US 2018/0310606 A1
(43) Pub. Date: Nov. 1, 2018

(54) Potato Piercing Assembly

(71) Applicants: Jason Sidrony, Freeport, FL (US); Chryseis Golden, Freeport, FL (US)

(72) Inventors: Jason Sidrony, Freeport, FL (US); Chryseis Golden, Freeport, FL (US)

(21) Appl. No.: 15/582,840

(22) Filed: May 1, 2017

(51) Int. Cl. A23P 30/00; B26F 1/24; A23L 19/12

(52) U.S. Cl. CPC A23P 30/00; A23V 2002/00; A23L 19/12; B26F 1/24

(57) ABSTRACT

A potato piercing assembly for preparing a potato to be cooked in a microwave oven includes a first dish that may have a potato positioned therein. A plurality of first spikes is provided and each of the first spikes is coupled to the first dish. Each of the first spikes pierces the potato when the potato is positioned in the first dish thereby preparing the potato to be cooked in a microwave oven. A second dish is hingedly coupled the first dish. The second dish is selectively positioned in a closed position such that each of the first dish and the second dish enclose the potato. A plurality of second spikes is provided and each of the second spikes is coupled to the second dish. In this way each of the second spikes pierces the potato when the second dish is closed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art Including Information Disclosed Under 37 CFR 1.97 and 1.98.

The disclosure and prior art relates to piercing devices and more particularly pertains to a new piercing device for preparing a potato to be cooked in a microwave oven.

### BRIEF SUMMARY OF THE INVENTION

An embodiment of the disclosure meets the needs presented above by generally comprising a first dish that may have a potato positioned therein. A plurality of first spikes is provided and each of the first spikes is coupled to the first dish. Each of the first spikes pierces the potato when the potato is positioned in the first dish thereby preparing the potato to be cooked in a microwave oven. A second dish is hingedly coupled the first dish. The second dish is selectively positioned in a closed position such that each of the first dish and the second dish enclose the potato. A plurality of second spikes is provided and each of the second spikes is coupled to the second dish. In this way each of the second spikes pierces the potato when the second dish is closed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a potato piercing assembly according to an embodiment of the disclosure showing a second dish in an open position.

FIG. 2 is a top phantom view of an embodiment of the disclosure.

FIG. 3 is a front view of an embodiment of the disclosure showing a second dish in a closed position.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

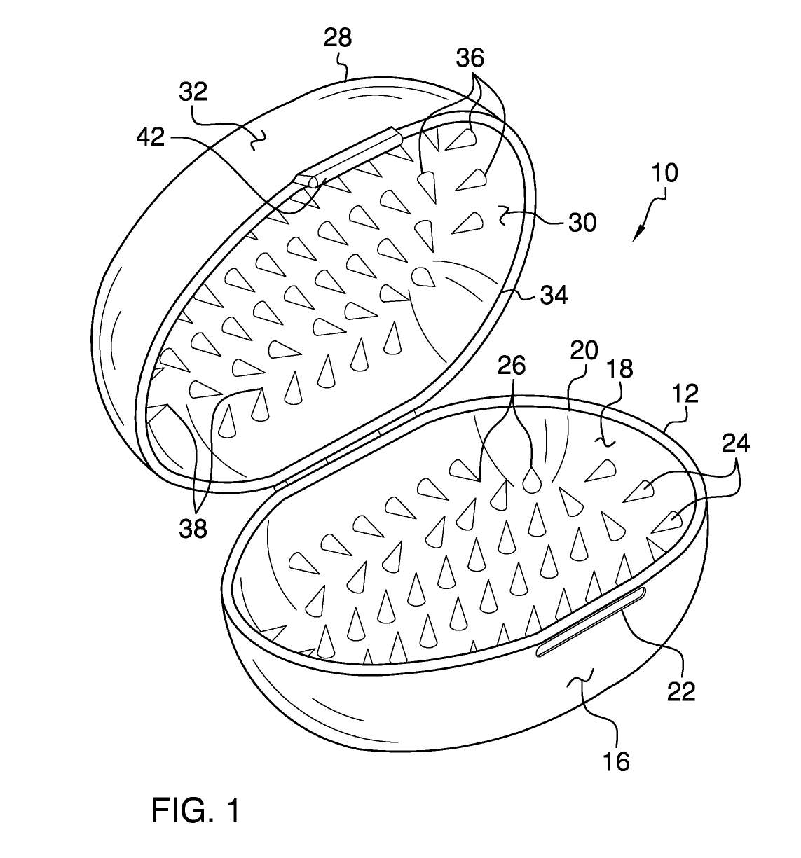

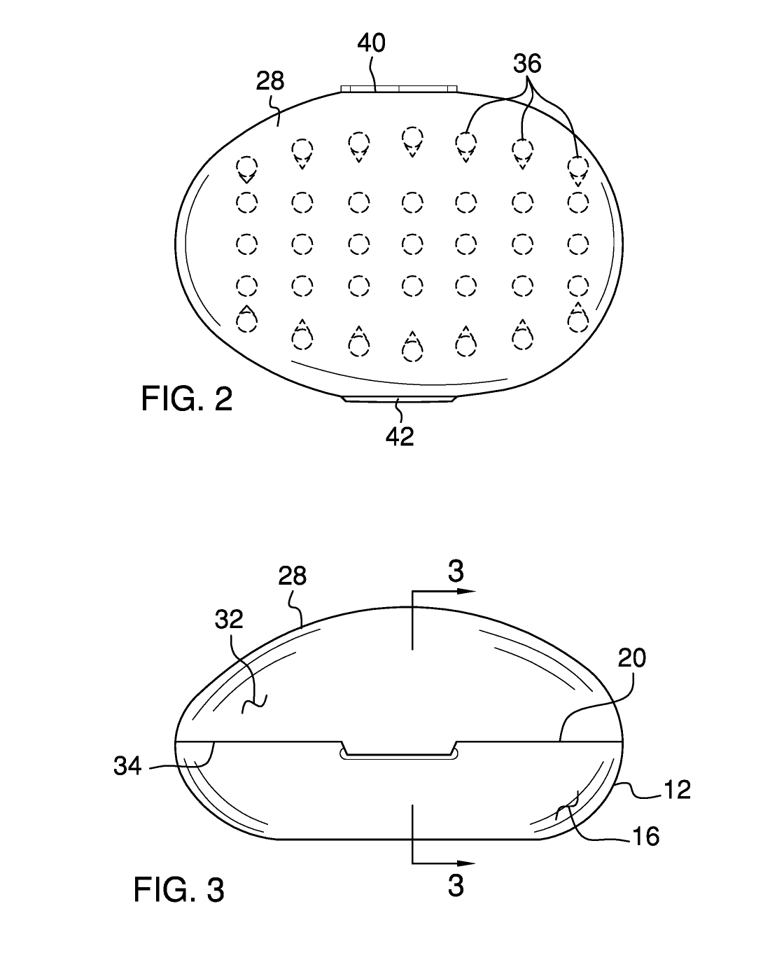

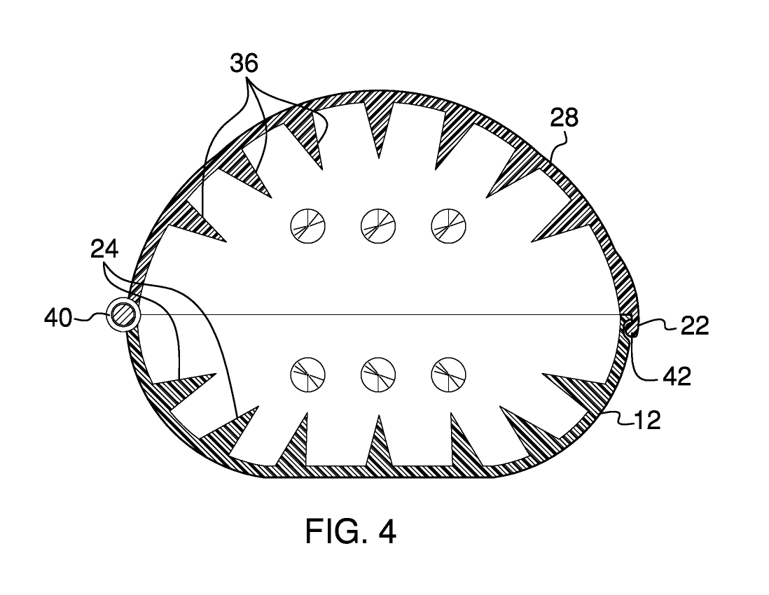

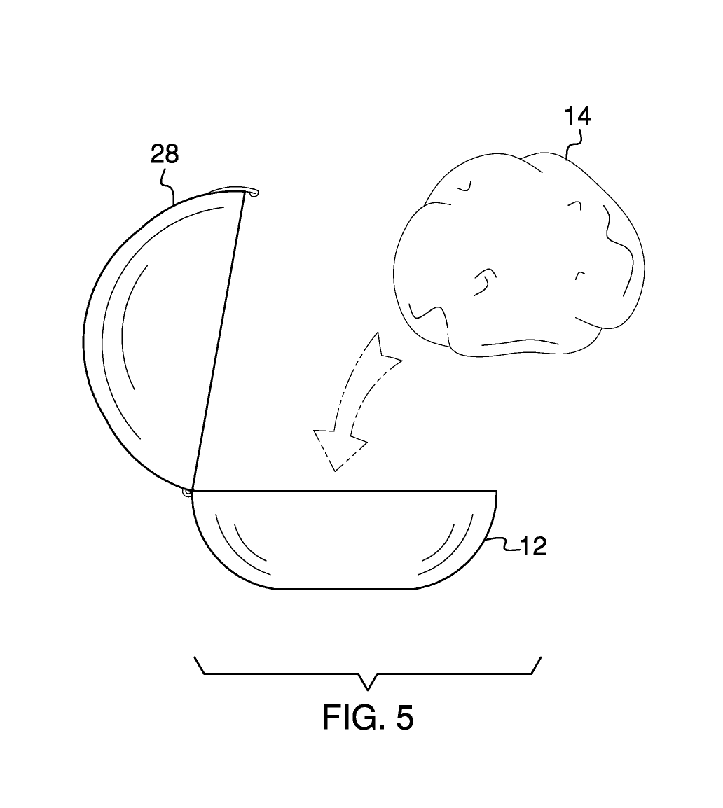

With reference now to the drawings, and in particular to FIGS. 1 through 5 thereof, a new piercing device embodying the principles and concepts of an embodiment of the disclosure and generally designated by the reference numeral 10 will be described.

As best illustrated in FIGS. 1 through 5, the potato piercing assembly 10 generally comprises a first dish 12 that may have a potato 14 positioned therein. The first dish 12 has an outer surface 16, an inner surface 18 and a peripheral edge 20 extending therebetween. Each of the inner 18 and outer 16 surfaces is concavely arcuate with respect to the peripheral edge 20 such that the first dish 12 has a hemispherical shape. Moreover, the first dish 12 is longitudinally elongated such that the first dish 12 has an ovoid shape. The outer surface 16 has a groove 22 extending toward the inner surface 18 and the groove 22 is aligned with the peripheral edge 20.

A plurality of first spikes 24 is provided and each of the first spikes 24 is coupled to the first dish 12. Each of the first spikes 24 pierces the potato 14 when the potato 14 is positioned in the first dish 12. The potato 14 is pierced to facilitate steam to exit the potato 14 when the potato 14 is cooked thereby inhibiting the potato 14 from exploding. In this way the potato 14 is prepared to be cooked in a microwave oven.

Each of the first spikes 24 is positioned on the inner surface 18 of the first dish 12. Each of the first spikes 24 has a distal end 26 with respect to the inner surface 18. Additionally, each of the first spikes 24 tapers to a point between the inner surface 18 and the distal end 26. The first spikes 24 are spaced apart from each other and are distributed on the inner surface 18. Each of the first spikes 24 may have a varying length with respect to each other.

A second dish 28 is provided and the second dish 28 is hingedly coupled the first dish 12. The second dish 28 is selectively positioned in a closed position such that each of the first 12 and second 28 dishes encloses the potato 14. The second dish 28 is biased into an open position. The second dish 28 has an inside surface 30, an outside surface 32 and a perimeter edge 34 extending therebetween. The perimeter edge 34 coextensively abuts the peripheral edge 20 of the first dish 12 when the second dish 28 is closed. Each of the inside surface 30 and the outside surface 32 is concavely arcuate with respect to the perimeter edge 34 such that the second dish 28 has a hemispherical shape. Additionally, the second dish 28 is longitudinally elongated such that the second dish 28 has an ovoid shape. Each of the first 12 and second 28 dishes may have a length ranging between approximately 17.0 cm and 20.0 cm, and a height and a width ranging between approximately 10.0 cm and 13.0 cm.

A plurality of second spikes 36 is provided and each of the second spikes 36 is coupled to the second dish 28. In this way the potato 14 is pierced when the second dish 28 is closed. Each of the second spikes 36 is positioned on the inside surface 30 of the second dish 28. Each of the second spikes 36 has a distal end 38 with respect to the inside surface 30. Moreover, each of the second spikes 36 tapers to a point between the inside surface 30 and the distal end 38 of the second spikes 36. The second spikes 36 are spaced apart from each other and are distributed on the inside surface 30. Each of the second spikes 36 may have a varying length with respect to each other.

A hinge 40 is coupled between the peripheral edge 20 of the first dish 12 and the perimeter edge 34 of the second dish 28. The hinge 40 may be a spring loaded hinge or the like. In this way the hinge 40 is biased to urge the second dish 28 into the open position. A tab 42 is coupled to the outside surface 32 of the second dish 28. The tab 42 extends beyond the peripheral edge 20 of the second dish 28 and the tab 42 is aligned with the groove 22 in the first dish 12. Thus, the tab 42 engages the groove 22 when the second dish 28 is closed to releasably retain the second dish 28 in the closed position.

In use, the potato 14 is placed in the first dish 12 and the second dish 28 is urged into the closed position. Thus, each of the first 24 and second 36 spikes pierces the potato 14 thereby preparing the potato 14 to be cooked in the microwave oven. The tab 42 engages the groove 22 when the second dish 28 is urged into the closed position. The tab 42 is manipulated to release the tab 42 from the groove 22. Thus, the hinge 40 biases the second dish 28 into the open position thereby facilitating the potato 14 to be removed from the first 12 and second 28 dishes. Moreover, the potato 14 is pierced without requiring the potato 14 to be manually pierced with a fork or the like. Thus, the first 12 and second 28 dishes reduce the likelihood that a user will be injured when the potato 14 is pierced. The potato 14 is placed in the microwave oven to be cooked.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A potato piercing system comprising:
a potato;
a first dish, said potato being positionable in said first dish;
a plurality of first spikes, each of said first spikes being coupled to said first dish;
a second dish being pivotally coupled to said first dish, said second dish being selectively positioned in a closed position wherein each of said first dish and said second dish enclose the potato, said second dish being biased into an open position;
a plurality of second spikes, each of said second spikes being coupled to said second dish wherein each of said second spikes is configured to pierce the potato when said second dish is closed; and
said first spikes and said second spikes piercing said potato when said second dish is in said closed position.

2. The system according to claim 1, wherein said first dish has an outer surface, an inner surface and a peripheral edge extending therebetween, said inner surface being concavely arcuate with respect to said peripheral edge and said outer surface being convexly arcuate with respect to said peripheral edge such that said first dish has a hollow shape, said first dish being longitudinally elongated such that said first dish has an ovoid shape.

3. The system according to claim 2, wherein said outer surface has a groove extending toward said inner surface, said groove being aligned with said peripheral edge.

4. The system according to claim 2, wherein each of said first spikes is positioned on said inner surface of said first dish, each of said first spikes having a distal end with respect to said inner surface, each of said first spikes tapering to a point between said inner surface and said distal end, said first spikes being spaced apart from each other and being distributed on said inner surface.

5. The system according to claim 1, wherein said second dish has an inside surface, an outside surface and a perimeter edge extending therebetween, said inside surface being concavely arcuate with respect to said perimeter edge and said outside surface being convexly arcuate with respect to said perimeter edge such that said second dish has a hollow shape, said second dish being longitudinally elongated such that said second dish has an ovoid shape.

6. The system according to claim 5, wherein each of said second spikes is positioned on said inside surface of said second dish, each of said second spikes having a distal end with respect to said inside surface, each of said second spikes tapering to a point between said inside surface and said distal end of said second spikes, said second spikes being spaced apart from each other and being distributed on said inside surface.

7. The system according to claim 5, further comprising a hinge being coupled between a peripheral edge of said first dish and said perimeter edge of said second dish, said hinge being biased to urge said second dish into said open position.

8. The system according to claim 5, further comprising:
a groove extending into said first dish; and
a tab being coupled to said outside surface of said second dish, said tab extending beyond said peripheral edge of sad second dish, said tab being aligned with said groove in said first dish, said tab engaging said groove when said second dish is closed to releasably retain said second dish in said closed position.

9. A potato piercing system comprising:
a potato;
a first dish, said potato being positionable in said first dish, said first dish having an outer surface, an inner surface and a peripheral edge extending therebetween, said inner surface being concavely arcuate with respect to said peripheral edge and said outer surface being convexly arcuate with respect to said peripheral edge such that said first dish has a hollow shape, said first dish being longitudinally elongated such that said first dish has an ovoid shape, said outer surface having a groove extending toward said inner surface, said groove being aligned with said peripheral edge;
a plurality of first spikes, each of said first spikes being coupled to said first dish wherein each of said first spikes is configured to pierce the potato when the potato is positioned in said first dish thereby preparing the potato to be cooked in a microwave oven, each of said first spikes being positioned on said inner surface of said first dish, each of said first spikes having a distal end with respect to said inner surface, each of said first spikes tapering to a point between said inner surface and said distal end, said first spikes being spaced apart from each other and being distributed on said inner surface;
a second dish being pivotally coupled to said first dish, said second dish being selectively positioned in a closed position wherein each of said first dish and said second dish are configured to enclose the potato, said second dish being biased into an open position, said second dish having an inside surface, an outside surface and a perimeter edge extending therebetween, said inside surface being concavely arcuate with respect to said perimeter edge and said outside surface being convexly arcuate with respect to said perimeter edge such that said second dish has a hollow shape, said second dish being longitudinally elongated such that said second dish has an ovoid shape;
a plurality of second spikes, each of said second spikes being coupled to said second dish wherein each of said second spikes is configured to pierce the potato when said second dish is closed, each of said second spikes being positioned on said inside surface of said second dish, each of said second spikes having a distal end with respect to said inside surface, each of said second spikes tapering to a point between said inside surface and said distal end of said second spikes, said second spikes being spaced apart from each other and being distributed on said inside surface;
said first spikes and said second spikes piercing said potato when said second dish is in said closed position;
a hinge being coupled between said peripheral edge of said first dish and said perimeter edge of said second dish, said hinge being biased to urge said second dish into said open position; and
a tab being coupled to said outside surface of said second dish, said tab extending beyond said peripheral edge of sad second dish, said tab being aligned with said groove in said first dish, said tab engaging said groove when said second dish is closed to releasably retain said second dish in said closed position.
